(19) United States
(12) Patent Application Publication
(10) Pub. No.: US 2014/0366756 A1
(43) Pub. Date: Dec. 18, 2014

(54) CLEANING ASSEMBLY AND METHOD FOR A PASTE MATERIAL PRINTER

(71) Applicant: Robert GRAY, Buford, GA (US)

(72) Inventor: Robert GRAY, Buford, GA (US)

(21) Appl. No.: 13/920,688

(22) Filed: Jun. 18, 2013

(51) Int. Cl. B41F 15/06

(52) U.S. Cl. CPC B41F 15/06
USPC 101/129; 101/425

(57) ABSTRACT

A cleaning assembly 114 and cleaning method for a screen printer 100 for paste material printing is disclosed herein. In a described embodiment, the cleaning assembly 114 comprises an image capturing device having a fiducial camera 124 arranged to move to respective fiducial positions for performing fiducial recognition of a number of fiduciary markers 202,204 on the PCB 200 and on a stencil 112 of the screen printer 100; and a cleaning device in the form of a cleaning blade 128 that is arranged to clean the stencil 112 during the movement of the image capturing device 124.

### BACKGROUND AND FIELD

This invention relates to a cleaning assembly and cleaning method for a screen printer, more particularly but not exclusively, for paste material or solder paste printing.

In surface mount technology (“SMT”), a screen printer comprises a stencil which is normally placed over a printed circuit board (“PCB”) having solder pads on which respective leads of a surface mount component are placed. The stencil includes apertures which correspond to respective solder pads and a solder paste printing process is used to print solder paste onto the solder pads.

With increasing miniaturization of SMT components and size of the PCB, and adoption of discrete devices such as 0201 and 01005 capacitors and resistors, reduction of pitches of CSP devices from 0.5 mm to 0.4 mm, 0.35 mm or 0.3 mm, especially for smart phone applications, means that sizes of the apertures of the stencil need to be correspondingly reduced. A recommended process practice is to have an area of contact for the solder paste on the solder pad and the stencil ratio to be above 0.6 and with the reduction in aperture sizes, the recommended ratio of 0.6 may be achieved by reducing stencil thickness. However, the reduction of stencil thickness may lead to soldering problems on larger components such as RF shields and connectors.

Further, the reduction in aperture sizes may cause solderability issues and bridging. To address these issues, it has been suggested to use standard under-stencil-wipers to clean the solder paste from underneath the stencil but this is not productive since the printing process needs to stop for the cleaning to take place. Also, this may lead to greater consumption of wipes and solvent used by the wiper.

Instead of reducing the stencil thickness, it has been proposed to provide solder paste with smaller particle sizes, using solder paste which is of a higher grade than the conventional solder paste. However, such higher grade solder paste is more expensive and is more prone to oxidation and solderability problems.

### SUMMARY

In a first aspect of the invention, there is provided a cleaning assembly for a screen printer, the cleaning assembly comprising an image capturing device arranged to move to respective fiducial positions for performing fiducial recognition of a number of fiduciary markers on a substrate and on a stencil of the screen printer; and a cleaning device arranged to clean the stencil of the screen printer during the movement of the image capturing device.

An advantage of the described embodiment is that, since the cleaning takes place concurrently with the movement of the image capturing device during the fiducial recognition process, a cycle time for cleaning the stencil may be reduced greatly. This may mean that the stencil may be cleaned more often to prevent bridging, mis-printing or solderability issues and defects, without increasing the cycle time.

Preferably, the cleaning device may be mounted to a body of the image capturing device to enable the cleaning device to move together with the image capturing device. In this way, this provides a convenient way of cleaning the stencil concurrently during the movement of the image capturing device.

The fiducial recognition and cleaning assembly may further comprise an actuator for actuating the cleaning device from a resting or standby position to a cleaning position for cleaning the stencil.

The cleaning device may be arranged to clean the stencil during movement of the image capturing device from a standby position to a first fiducial position for capturing images of a first fiduciary marker on each of the substrate and the stencil. Alternatively, or in addition, the cleaning device may be arranged to clean the stencil during the movement of the image capturing device from a first fiducial position for capturing images of a first fiduciary marker on each of the substrate and the stencil, to a second fiducial position for capturing images of a second fiduciary marker on each of the substrate and the stencil. Further, the cleaning device may be arranged to clean the stencil during the movement of the image capturing device from the second fiducial position to a standby position.

Specifically, the cleaning device may include one or more cleaning blades for scraping residual paste material away from a bottom side of the stencil. It is preferred, although not necessary, for the one or more cleaning blades to be mounted to a body of the image capturing device.

In a second aspect of the invention, there is provided a cleaning method for a screen printer, the method comprising the steps of moving an image capturing device to respective fiducial positions for performing fiducial recognition of a number of fiduciary markers on a substrate and on a stencil of the screen printer; and cleaning the stencil of the screen printer during the movement of the image capturing device.

Preferably, the cleaning device may be mounted to a body of the image capturing device, and the method may thus include moving the cleaning device and the image capturing device together.

The method may include actuating the cleaning device from a resting (or standby) position to a cleaning position for cleaning the stencil.

The method may comprise moving the image capturing device from a standby position to a first fiducial position for capturing images of a first fiduciary marker on each of the substrate and the stencil; and cleaning the stencil during the movement of the image capturing device. Alternatively, or in addition, the method may comprise moving the image capturing device from a first fiducial position for capturing images of a first fiduciary marker on each of the substrate and the stencil, to a second fiducial position for capturing images of a second fiduciary marker on each of the substrate and the stencil; and cleaning the stencil during the movement of the image capturing device. The method may also include moving the image capturing device from the second fiducial position to a standby position; and cleaning the stencil during the movement of the image capturing device.

Preferably, cleaning the stencil may include scraping residual paste material away from a bottom side of the stencil.

The references to “paste material” that are used in this application to include solder paste, adhesive, and epoxy materials etc, depending on what is to be printed on the substrate.

The references to “screen printer” include any sort of apparatus for paste material printing.

It should be appreciated that features relating to one aspect may also be applicable to the other aspects.

### BRIEF DESCRIPTION OF THE DRAWINGS

An example of the invention will now be described with reference to the accompanying drawings, in which:

FIG. 1 is a perspective view of a screen printer, with covers lifted, according to a preferred embodiment of the invention;

FIG. 2 is a bottom perspective view of the screen printer of FIG. 1, with the covers and a number of other parts omitted to show a set mounting frames, a stencil, a PCB and a fiducial recognition and cleaning assembly;

FIG. 3 is an end view of the screen printer of FIG. 2, in direction A in FIG. 2;

FIG. 4 is a simplified plan view of a PCB (with print pattern and apertures omitted) used in a print cycle by the screen printer of FIG. 1;

FIG. 5 is an enlarged view of portion B of FIG. 3 to show a fiducial camera and a cleaning blade of the fiducial recognition and cleaning assembly more clearly; and

FIG. 6 is a simplified control block diagram of the screen printer of FIG. 1.

### DETAILED DESCRIPTION OF THE PREFERRED EMBODIMENTS

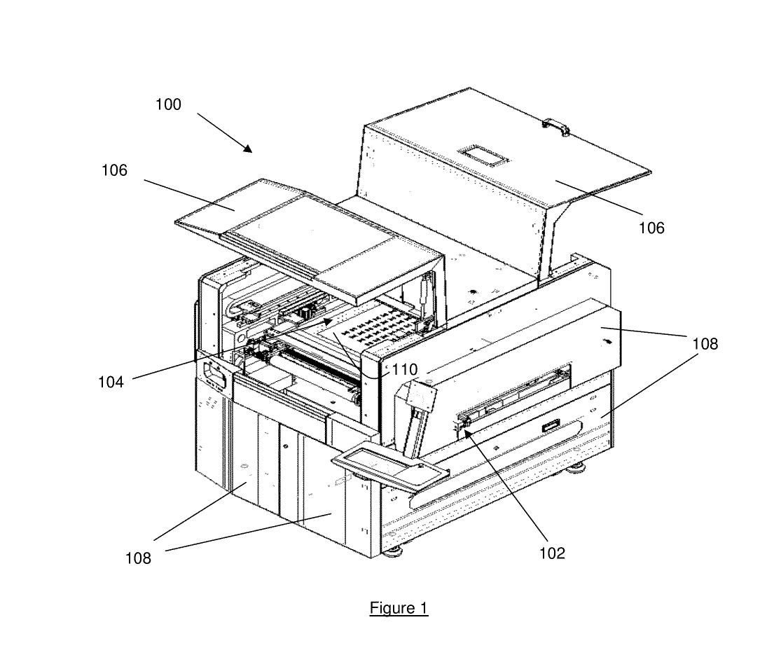

FIG. 1 is a perspective view of a screen printer 100 for solder paste printing, the screen printer 100 comprising a conveyor system 102 for conveying substrates such as printed circuit boards (PCBs) (not shown) into a printing chamber 104 of the screen printer 100. The screen printer 100 includes a pair of pivotable covers 106, shown in open positions in FIG. 1, to allow access to the printing chamber 104 and the pair of pivotable covers 106 is normally closed during operation of the screen printer 100. The screen printer 100 further includes a number of protective panels 108.

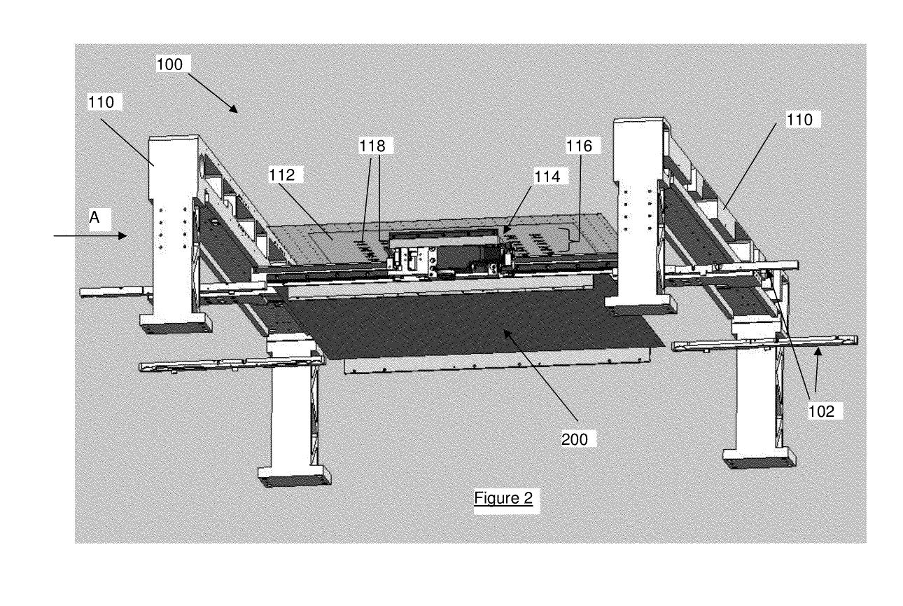

FIG. 2 is a bottom perspective view of the screen printer 100 with a number of parts, including the protective panels 108, omitted to show a set of mounting frames 110 for supporting a stencil 112 and a fiducial recognition and cleaning assembly 114.

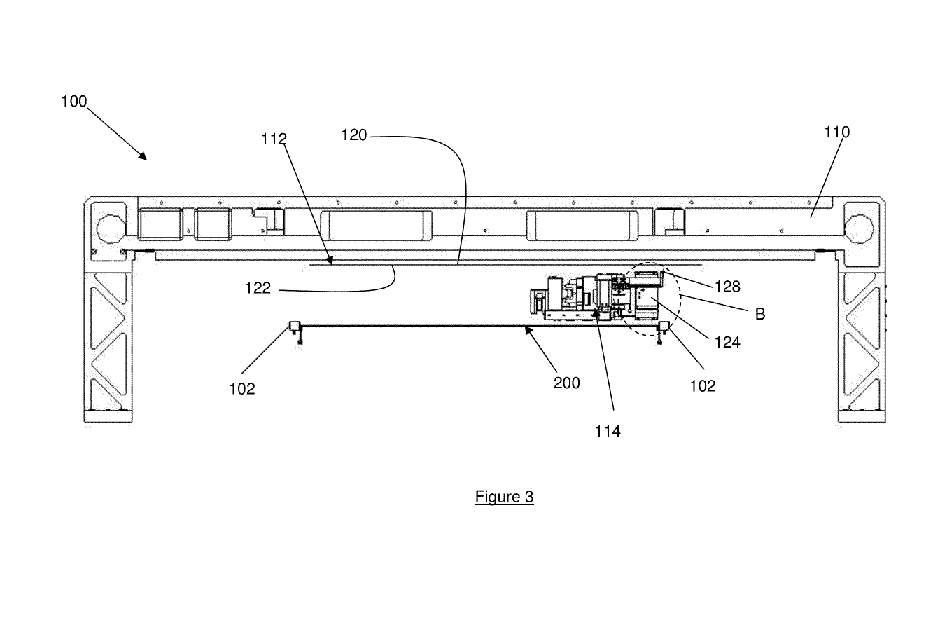

FIG. 3 is an end view of the screen printer 100 of FIG. 2, in direction A in FIG. 2.

The stencil 112 has a print pattern 116 defined by a plurality of apertures 118 through which paste material is deposited onto respective solder pads of a PCB 200. In this embodiment, the paste material is solder paste. The stencil 112 is substantially planar and includes a top side 120 on which the solder paste is dispensed and a bottom side 122 which engages the PCB 200, and have sides extending generally in respective X-axis and Y-axis of the PCB 200.

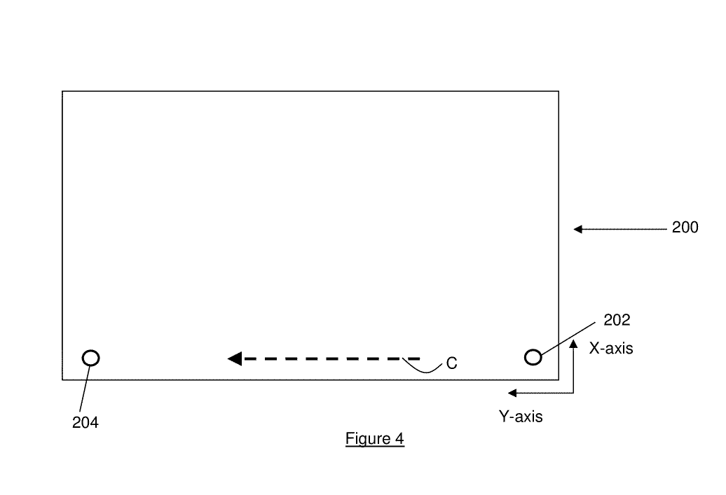

FIG. 4 is a simplified schematic diagram of the PCB 200. For the sake of simplicity, it does not show any artwork or solder pads, which would normally be present. The PCB 200 includes a first fiduciary marker 202 and a second fiduciary marker 204 which are reference points for determining orientation and alignment of the PCB 200 vis-a-vis the stencil 112 based on corresponding fiducial markers on the stencil 112.

The fiducial recognition and cleaning assembly 114 includes an image capturing device and in this embodiment, it is a fiducial camera 124 mounted to guide tracks (not shown) in a usual manner for moving the fiducial camera 124 to respective fiducial positions for recognition of the fiduciary markers 202,204 on the PCB 200, as well as corresponding fiducial markers on the stencil 112 in order to ensure an accurate alignment between the PCB 200 and the stencil 112 during the printing operation. Specifically, the fiducial camera 124 is arranged to move between the stencil 112 and the PCB 200 i.e. below the stencil 112 and above the PCB 200.

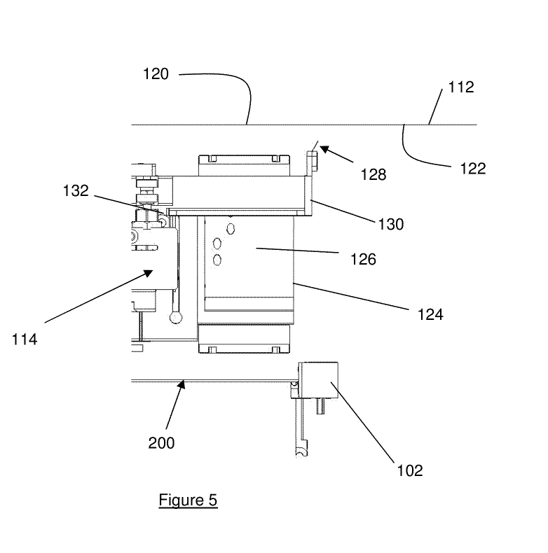

FIG. 5 is a close-up view of portion B of FIG. 3 and it should be appreciated that the fiducial camera 124 is arranged to point downwards to capture images of the fiduciary markers 202,204 of the PCB 200, and to point upwards to capture the images of the corresponding fiducial markers on the stencil 112. Also, the fiducial camera 124 includes a camera body 126. In this embodiment, the fiducial recognition and cleaning assembly 114 includes a cleaning blade 128 mounted to the camera body 126 via a support frame 130 (to which the camera body 126 is coupled) so that movement of the cleaning blade 128 is synchronized with the movement of the fiducial camera 124. The cleaning blade 128 has a longitudinal axis which is aligned to the X-axis of the PCB 200 and substantially orthogonal to the Y-axis of the PCB 200.

The fiducial recognition and cleaning assembly 114 includes an actuator 132 for moving the support frame 130 and, thereby, the cleaning blade 128 towards the stencil 112 to contact with the bottom side 122 of the stencil 112. In this way, the cleaning blade 128 is arranged to clean or scrape the bottom side 122 of the stencil 112 during the movement of the fiducial camera 124.

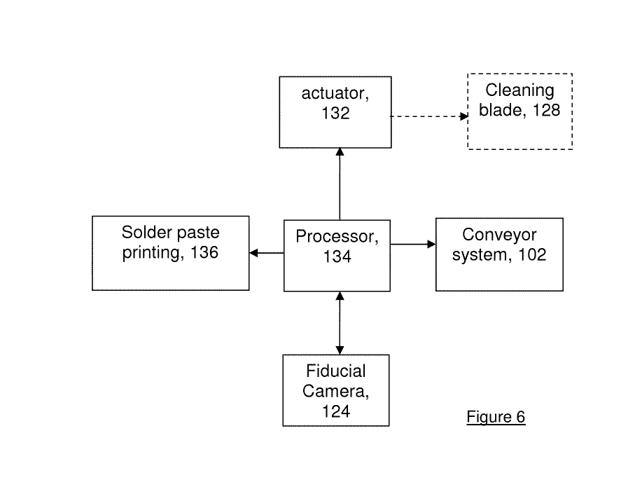

An operation of the fiducial recognition and cleaning assembly 114 will now be described, with particular reference to FIG. 6, which is a simplified control block diagram of the screen printer 100 illustrating a processor 134 controlling the various parts of the fiducial recognition and cleaning assembly 114.

A new print cycle begins with loading of the PCB 200 by the conveyor system 102 into the printing chamber 104. A PCB stopper (not shown, and controlled by the processor 134) extends to stop the PCB 200 at a predetermined position below the stencil 112. For the purposes of this operation, the stencil 112 has already been used for an earlier printing cycle and is not yet cleaned. The PCB stopper is next retracted and the PCB 200 is lifted by the conveyor system 102 to a vision recognition height. The processor 124 then activates the actuator 132 to move the support frame 130 and, thereby, the fiducial camera 124 from a resting or parked position to a first fiducial position to capture an image of the first fiduciary marker 202 on the PCB 200, as well as the corresponding first fiducial marker on the stencil 112. Contemporaneously, the cleaning blade 128 contacts the bottom side 122 of the stencil 112 as the fiducial camera 124 is being positioned to the first fiducial position, i.e. at a cleaning position. Accordingly, the cleaning of the bottom side 122 of the stencil 112 by the cleaning blade 128 may begin as the fiducial camera 124 moves from its resting position to the first fiducial position.

After the fiducial camera 124 has successfully captured the first fiducial markers on the PCB 200 and the stencil 112, the processor 124 controls the actuator 132 to move the fiducial camera 124 in the direction of arrow C (see FIG. 4), from the first fiducial position to a second fiducial position for recognizing the second fiduciary marker 204 on the PCB 200, as well as the corresponding second fiducial marker on the stencil 112. Contemporaneously with the movement of the fiducial camera 124, the cleaning blade 128 scraps off any residual solder paste as a result of the earlier print cycle from the bottom side 122 of the stencil 112. After capturing the images of the second fiduciary marker 204 on the PCB 200 and the corresponding second fiduciary marker on the stencil 112, the fiducial camera 124 (together with the cleaning blade 128) moves to its standby position. It should be appreciated that the cleaning of the bottom side 122 of the stencil 112 by the cleaning blade 128 continues as the fiducial camera 124 moves to its standby position, because the cleaning blade 128 still maintains contact with the bottom side 122 of the stencil 112.

Based on the captured images of the fiducial markers, the PCB 200 is repositioned to align with the stencil 200 if necessary. Thereafter, the PCB 200 is further lifted by the conveyor system 102 to contact with the stencil 200 to begin solder paste printing 136 in a usual manner. After printing, the PCB 200 is lowered to a transport height for the conveyor system 102 to convey it to an output section for a next process. The screen printer 100 is now ready for printing the next PCB 200.

In the standby position, and preferably also during the transportation of the PCB 200 to the output section, the cleaning blade 128 may be cleaned or wiped by a static rubber squeegee to remove the scraped solder paste and keep the cleaning blade 128 clean.

The above steps are repeated with the cleaning of the stencil 200 being carried out simultaneously or concurrently with the movement of the fiducial camera 124, for example, between the first and second fiducial positions. In this way, the cycle time is reduced substantially as opposed to conventional wiping or cleaning. Indeed, due to the reduced cycle time, it is possible (although not necessary), for the stencil 200 to be cleaned by the fiducial recognition and cleaning assembly 114 during each print cycle (i.e. during the fiducial recognition stage) and this may greatly reduce solderability and bridging issues. Further, the cleaning may reduce solder paste volume variation, thus improving the quality of the paste printing. Further, it has been found that this cleaning process may be particularly useful when manufacturing PCBs for smart phone applications since this may result in faster cycle time, better quality printing and reduced use of consumables for cleaning the stencil 112.

The described embodiment should not be construed as limitative. For example, the references to “screen printer” or “stencil printer” may be used interchangeably. Similarly, references to “stencil” or “screen” may also be used interchangeably. Alternatively, the described embodiment may be adapted for stencil printers, not just screen printers. Also, the printing may be performed on other types of substrates (such as a ceramic substrate) not just PCBs. Likewise, not just solder paste but other types of paste material may be used, such as epoxy materials. Also, the actuator 132 may not be necessary if the guide tracks supporting the fiducial camera 124 are configured to lift the fiducial camera 124 upwards in order for the cleaning blade 128 to engage the bottom side 122 of the stencil 112.

It is envisaged that the cleaning blade 128 (or generally the cleaning device) need not be mounted to the camera body 126. For example, the cleaning blade 128 may be independently supported and separated from the camera body 126 and the cleaning of the stencil 112 is performed by the cleaning blade 128 during the movement of the fiducial camera 124 to achieve the cycle time reduction.

Further, the cleaning blade 128 may be arranged between an extended position and a retracted position. For instance, the cleaning blade 128 may extend from a retracted position to contact the bottom side 122 of the stencil 122 as the fiducial camera 124 is positioned between the first and second fiducial positions, while the extended cleaning blade 128 may retract to the retracted position in its standby position.

Instead of one cleaning blade 128, there may be more than one cleaning blade 128, and it is preferable to use twin cleaning blades so that the scraping of residual solder paste from the bottom side 122 of the stencil 112 may be more effective. The cleaning of the stencil 112 by the cleaning blade 128 may also be performed during the movement of the fiducial camera 124 from its standby position to the first fiducial position and/or from the second fiducial position to its standby position and this may provide a better cleaning coverage. In other words, broadly, it is envisaged that the cleaning of the stencil 112 may be performed concurrently during the movement of the fiducial camera 124.

Also, besides using the cleaning blade 128, other types of cleaning methods may be employed. For example, it is envisaged that, as an alternative or in addition, vacuum from a local venturi system may be used for cleaning the apertures if needed, or a conventional wiping device may be used too which wipes/cleans the stencil concurrently as the movement of the fiducial camera 124.

The PCB may have more than two fiduciary markers 202, 204 and it would be appreciated that cleaning is thus performed during the movement of the fiducial camera 124 from any one of the fiduciary markers to another fiduciary marker.

Having now fully described the invention, it should be apparent to one of ordinary skill in the art that many modifications can be made hereto without departing from the scope as claimed.

1. A cleaning assembly for a screen printer, the cleaning assembly comprising
an image capturing device arranged to move to respective fiducial positions for performing fiducial recognitions of a plurality of fiduciary markers on a substrate and on a stencil of the screen printer; and
a cleaning device arranged to clean the stencil during the movement of the image capturing device.

2. The cleaning assembly according to claim 1, wherein the cleaning device is mounted to a body of the image capturing device to enable the cleaning device to move together with the image capturing device.

3. The cleaning assembly according to claim 1, further comprising an actuator for actuating the cleaning device from a resting position to a cleaning position for cleaning the stencil.

4. The cleaning assembly according to claim 1, wherein the cleaning device is arranged to clean the stencil during the movement of the image capturing device from a standby position to a first fiducial position for capturing images of a first fiduciary marker on each of the substrate and the stencil.

5. The cleaning assembly according to claim 1, wherein the cleaning device is arranged to clean the stencil during the movement of the image capturing device from a first fiducial position for capturing images of a first fiduciary marker on each of the substrate and the stencil, to a second fiducial position for capturing images of a second fiduciary marker on each of the substrate and the stencil.

6. The cleaning assembly according to claim 5, wherein the cleaning device is arranged to clean the stencil during the movement of the image capturing device from the second fiducial position to a standby position.

7. The cleaning assembly according to claim 1, wherein the cleaning device includes one or more cleaning blades for scraping residual paste material away from a bottom side of the stencil.

8. The cleaning assembly according to claim 7, wherein the one or more cleaning blades is mounted to a body of the image capturing device.

9. A cleaning method for a screen printer, the method comprising the steps of
moving an image capturing device to respective fiducial positions for performing fiducial recognition of a plurality of fiduciary markers on a substrate and on a stencil of the screen printer; and
cleaning the stencil during the movement of the image capturing device.

10. The cleaning method according to claim 9, wherein the cleaning device is mounted to a body of the image capturing device, and the step of cleaning the stencil includes moving the cleaning device and the image capturing device together.

11. The cleaning method according to claim 9, further comprising the step of actuating the cleaning device from a resting position to a cleaning position for cleaning the stencil.

12. The cleaning method according to claim 9, further comprising the steps of
moving the image capturing device from a standby position to a first fiducial position for capturing images of a first fiduciary marker on each of the substrate and the stencil; and
cleaning the stencil during the movement of the image capturing device.

13. The cleaning method according to claim 9, further comprising the steps of
moving the image capturing device from a first fiducial position for capturing images of a first fiduciary marker on each of the substrate and the stencil, to a second fiducial position for capturing images of a second fiduciary marker on each of the substrate and the stencil; and
cleaning the stencil during the movement of the image capturing device.

14. The cleaning method according to claim 13, further comprising the steps of
moving the image capturing device from the second fiducial position to a standby position; and
cleaning the stencil during the movement of the image capturing device.

15. The cleaning assembly according to claim 9, wherein the step of cleaning the stencil includes scraping residual paste material away from a bottom side of the stencil.
